(19) United States
(12) Patent Application Publication
(10) Pub. No.: US 2026/0344707 A1
(43) Pub. Date: Nov. 5, 2026

(54) FOOD COMPOSITIONS FOR COMPANION ANIMALS

(71) Applicant: MARS, INCORPORATED, McLean, VA (US)

(72) Inventors: Isabelle Lesponne, Aimargues (FR); Lara Fossati, Aimargues (FR); Laura Fauviau, Aimargues (FR); Maxime Saublet, Aimargues (FR); Bénédicte Garzino, Aimargues (FR); Dominique Lobbe, Aimargues (FR)

(73) Assignee: MARS, INCORPORATED, McLean, VA (US)

(21) Appl. No.: 19/117,865

(22) PCT Filed: Oct. 6, 2023
(86) PCT No.: PCT/US2023/034669

§ 371 Date: Apr. 2, 2025

(30) Foreign Application Priority Data
Oct. 7, 2022 (EP) 22200209.9

(51) Int. Cl. A23K 50/42; A23K 10/30; A23K 20/147; A23K 20/158; A23K 20/174; A23K 20/179; A23K 20/24; A23K 20/26; A23K 50/60

(52) U.S. Cl. CPC A23K 50/42; A23K 10/30; A23K 20/147; A23K 20/158; A23K 20/174; A23K 20/179; A23K 20/24; A23K 20/26; A23K 50/60

(57) ABSTRACT

The present disclosure relates to a hypoallergenic nutritionally complete dry food composition for companion animals, particularly for puppies. The hypoallergenic nutritionally complete dry food composition for a puppy, wherein said composition comprises: from about 20% to about 25% by weight of vegetal proteins, said vegetal proteins comprising at least about 95% by weight of hydrolyzed vegetal proteins, from about 15% to about 25% by weight of fat, from about 200 ppm to about 500 ppm by weight of vitamin C, from about 400 ppm to about 900 ppm by weight of vitamin E, from about 0.5% to about 2% by weight of calcium (Ca), from about 0.5% to about 1.5% by weight of phosphorus (P), and from about 0.5% to about 1.5% by weight of threonine (Thr), the weight percentage and ppm being expressed on a dry matter basis.

### CROSS REFERENCE TO RELATED APPLICATIONS

This application claims priority to European Patent Application No. 22200209.9, filed on Oct. 7, 2022, which is incorporated herein by reference in its entirety.

### FIELD OF THE DISCLOSURE

The present disclosure relates to the field of food compositions for companion animals, especially for puppies, and uses thereof.

### BACKGROUND OF THE DISCLOSURE

Companion animals, such as dogs and cats, require differing diets depending on their age, size, body composition, medical problems and often breed. Both dog and cat nutrient requirements can be separated into three different categories based on the life stage which are: growing animals, such as puppies, adult animals, and senior animals.

Like human babies, the first years of an animal's life are marked by rapid growth and development. Tissues and organs continue to form, develop, and mature into adult levels and functionalities. Therefore, companion animals during the growth, require adapted dietary compositions to support its energy needs and tissue-building requirements.

However, certain commercial diets indicated for growth can contain allergens that could cause adverse immune reactions and/or food intolerance in companion animals, especially in young animals, which are particularly susceptible.

This condition, also known as an adverse food reaction, is usually an abnormal response to animal and/or vegetal proteins found in commercial pet food leading to a resistance to feed of companion animals, especially puppies, with detrimental impacts on their health. Adverse food reactions can present dermatological lesions and/or gastrointestinal problems, such as vomiting or diarrhea, that can cause discomfort and pain in companion animals.

There are currently food compositions on the market supposed to be considered, or presented as, hypoallergenic, but none of them have been specifically designed to fulfill the specific requirement of a food for a young animal, particularly a puppy. It can be mentioned that, said requirements for a puppy food composition are considered, according to the current knowledge of the person skilled in the art, difficult to reconcile with the requirements of a hypoallergenic food composition.

Nevertheless, said food compositions do not provide effective nutritional content and contain animal proteins that can cause allergic reactions in companion animals that consume it.

Thus, there is a need for alternative hypoallergenic food compositions that promote and/or support the growth of a companion animal, in particular a puppy, for decreasing or minimizing the risk of adverse food reactions while remaining palatable.

There is a need for novel hypoallergenic food compositions for promoting and/or supporting the growth of a companion animal, in particular a puppy, especially for a companion animal suffering from adverse food reaction.

There is a need for novel hypoallergenic food compositions reducing the likelihood of occurrence of adverse food reactions in a companion animal, in particular a puppy.

In addition, novel hypoallergenic diets should be palatable, well tolerated and digested by the companion animal and be easily produced.

There is a need for novel hypoallergenic dry food compositions adapted to puppies, with such regard to the size and/or the texture of the dry food composition.

There is a need for novel hypoallergenic dry food compositions palatable for a companion animal, such as a puppy.

The present disclosure has for purpose to satisfy all or part of the above-mentioned needs.

### SUMMARY OF THE DISCLOSURE

It has been developed a food composition including ingredients that are formulated to prevent or minimize the risk of adverse food reaction in a companion animal, especially a puppy. The food composition of the disclosure is also formulated to support the development and the growth of a companion animal, especially a puppy.

According to a first aspect, the present disclosure relates to a hypoallergenic nutritionally complete dry food composition for a companion animal, in particular a puppy, wherein said composition can include:
from about 20% to about 25% by weight of vegetal proteins, said vegetal proteins having at least about 95% by weight of hydrolyzed vegetal proteins,
from about 15% to about 25% by weight of fat,
from about 200 ppm to about 500 ppm by weight of vitamin C,
from about 400 ppm to about 900 ppm by weight of vitamin E,
from about 0.5% to about 2% by weight of calcium (Ca),
from about 0.5% to about 1.5% by weight of phosphorus (P), and
from about 0.5% to about 1.5% by weight of threonine (Thr),
the weight percentage and ppm being expressed on a dry matter basis.

Indeed, the said hypoallergenic nutritionally complete dry food composition can comprise other substances (such as fiber, lutein, taurine, beta-carotene, natural flavor(s), etc.) so that its composition amounts to 100% by weight on a dry matter basis.

In some embodiments, the vegetal proteins within the composition as disclosed herein can include at least about 99% by weight of hydrolyzed vegetal proteins on a dry matter basis.

In some embodiments, the hydrolyzed vegetal proteins within the composition as disclosed herein can have a molecular weight of 30,000 Dalton (Da) or less.

In some embodiments, the source of hydrolyzed vegetal proteins can be soya, rice, and/or a combination thereof.

In some embodiments, the source of fat can be a vegetal fat source and/or animal fat source.

In some embodiments, fat within the food composition can include both fat from vegetal source and animal source.

In some embodiments, vegetal fat can be selected from various sources, which include, without limitation, from wheat, sunflower, safflower, rapeseed, olive, borage, flaxseed, peanuts, blackcurrant seed, cottonseed, germ, corn germ, algae, and/or a combination thereof.

In some embodiments, animal fat can be selected from a source of fat selected from fish oil, krill oil, and/or a combination thereof.

In some embodiments, the weight ratio of vegetal fat to animal fat can range from about 1:1 to about 2:1.

In some embodiments, a hypoallergenic nutritionally complete dry food composition as disclosed herein can further include fibers in a range of about 3% to about 8% by weight based on dry matter basis.

In some embodiments, fibers can include soluble and insoluble fibers.

In some embodiments, the weight ratio of soluble fibers to insoluble fibers can range from about 1:2 to about 1:1.

In some embodiments, soluble fibers can be selected from, without limitation, beet pulp, guar gum, chicory pulp, chicory root, psyllium, pectin, blueberry, cranberry, squash, apples, oats, beans, citrus, barley, peas, and/or a combination thereof.

In some embodiments, insoluble fibers can originate from fiber sources selected from, without limitation, cellulose, whole wheat products, wheat oat, corn bran, flax seed, grapes, celery, green beans, cauliflower, potato skins, fruit skins, vegetable skins, peanut hulls, soy fiber, and/or a combination thereof.

In some embodiments, a hypoallergenic nutritionally complete dry food composition as disclosed herein can further include at least one natural flavor.

In some embodiments, a hypoallergenic nutritionally complete dry food composition as disclosed herein can have a Metabolizable Energy (ME) of about 4000 kcal/kg, as measured according to the NRC 2006.

In some embodiments, a hypoallergenic nutritionally complete dry food composition as disclosed herein can further include from about 3% to about 7% by weight of lutein, on a dry matter basis.

In some particular embodiments, the amount of lutein within the food composition can range from about 4% to about 6% by weight on a dry matter basis.

In some particular embodiments, the amount of lutein within the food composition can range from about 4.8% to about 5.2% by weight on a dry matter basis.

In some embodiments, a hypoallergenic nutritionally complete dry food composition as disclosed herein can further include from about 0.1% to about 2% by weight of taurine, on a dry matter basis.

In some particular embodiments, the amount of taurine can range from about 0.3% to about 1% by weight on a dry matter basis.

In some particular embodiments, the amount of taurine can range from about 0.4% to about 0.6% by weight on a dry matter basis.

In some embodiments, a hypoallergenic nutritionally complete dry food composition as disclosed herein can further include from about 1.5 ppm to about 10 ppm by weight of beta-carotene, on dry matter basis.

In some particular embodiments, the amount of beta-carotene can range from about 2 ppm to about 7 ppm by weight on dry matter basis.

In some particular embodiments, the amount of beta-carotene can range from about 4 ppm to about 5 ppm by weight on dry matter basis.

In some embodiments, a hypoallergenic nutritionally complete dry food composition as disclosed herein can be a kibble, particularly a kibble having a size that does not exceed about 10.5 mm×10.5 mm×4 mm.

In some embodiments, a companion animal, particularly a puppy, can be less than about 15 months, and more particularly less than about 6 months old companion animal.

In some embodiments, a companion animal, particularly a puppy, can be 1 month old, 2 months old, 3 months old, 4 months old, 5 months old or 6 months old companion animal.

In another aspect, the present disclosure also relates to the use of a hypoallergenic nutritionally complete dry food composition as disclosed herein for promoting and/or supporting the growth of a companion animal, especially for promoting and/or supporting the growth of a companion animal suffering from adverse food reaction, the said companion animal being most preferably a puppy.

In another aspect, the present disclosure also concerns a method for promoting and/or supporting the growth of a companion animal comprising at least a step of providing a hypoallergenic nutritionally complete dry food composition to the companion animal wherein the hypoallergenic nutritionally complete dry food composition can include:
from about 20% to about 25% by weight of vegetal proteins, said vegetal proteins having at least 95% by weight of hydrolyzed vegetal proteins,
from about 15% to about 25% by weight of fat,
from about 200 ppm to about 500 ppm by weight of vitamin C,
from about 400 ppm to about 900 ppm by weight of vitamin E,
from about 0.5% to about 2% by weight of calcium (Ca),
from about 0.5% to about 1.5% by weight of phosphorus (P), and
from about 0.5% to about 1.5% by weight of threonine (Thr),
the weight percentage and ppm being expressed on a dry matter basis.

Indeed, the said hypoallergenic nutritionally complete dry food composition can comprise other substances (such as fiber, lutein, taurine, beta-carotene, natural flavor(s), etc.) so that its composition amounts to 100% by weight on a dry matter basis.

In some embodiments of the above method, the hypoallergenic nutritionally complete dry food composition can be provided to a companion animal, particularly a puppy, which is affected with adverse food reaction, or a companion animal which is likely to be affected with adverse food reaction.

In another aspect, the present disclosure also relates to a method for reducing the likelihood of occurrence of adverse food reaction in a companion animal, especially a puppy, said method comprising at least a step of providing to the puppy a hypoallergenic nutritionally complete dry food composition as disclosed herein.

The present disclosure also relates to a method of manufacturing a hypoallergenic nutritionally complete dry food composition as described herein, can include the steps of:
a) mixing:
from about 20% to about 25% by weight of vegetal proteins, said vegetal proteins having at least about 95% by weight of hydrolyzed vegetal proteins,
from about 15% to about 25% by weight of fat,
from about 200 ppm to about 500 ppm by weight of vitamin C,
from about 400 ppm to about 900 ppm by weight of vitamin E,
from about 0.5% to about 2% by weight of calcium (Ca),
from about 0.5% to about 1.5% by weight of phosphorus (P), and
from about 0.5% to about 1.5% by weight of threonine (Thr),
thereby obtaining a mixture, the weight percentage and weight ppm being expressed on a dry matter basis; and
b) heating the mixture and obtaining the said hypoallergenic nutritionally complete dry food composition.

### DETAILED DESCRIPTION OF THE DISCLOSURE

The objective of the present disclosure is to provide a well-tolerated new hypoallergenic dry food composition, including hydrolyzed vegetal protein, an optimal nutritional level of proteins, vitamins, calcium, phosphorus, threonine and/or fat for a companion animal, preferably a puppy, especially those susceptible or predisposed to adverse food reaction or those suffering from adverse food reaction.

The food composition as described herein does not provoke allergic reaction in companion animals. In particular, the food composition of the present disclosure is formulated to avoid or at least minimized the risk of a food aversion.

For clarity and not by way of limitation, the detailed description of the presently disclosed subject matter is divided into the following subsections:
1. Definitions;
2. Hypoallergenic nutritionally complete dry food composition;
3. Method for manufacturing hypoallergenic nutritionally complete dry food composition; and
4. Uses of hypoallergenic nutritionally complete dry food compositions.

### 1. DEFINITIONS

The terms used in this specification generally have their ordinary meanings in the art, within the context of this subject matter and in the specific context where each term is used. Certain terms are defined below, or elsewhere in the specification, to provide additional guidance in describing the compositions and methods of the disclosed subject matter and how to make and use them.

As used in the specification and the appended claims, the singular forms “a”, “an”, and “the” include plural referents unless the context clearly dictates otherwise. Thus, for example, reference to “a compound” includes mixtures of compounds.

The terms “comprise(s),” “comprising”. “include(s),” “including”, “having,” “has,” “can,” “contain(s),” and variants thereof, as used herein, are intended to be open-ended transitional phrases, terms, or words that do not preclude the possibility of additional acts or structures. The present disclosure also contemplates other embodiments “comprising,” “consisting of,” and “consisting essentially of,” the embodiments or elements presented herein, whether explicitly set forth or not.

The term “about” means within an acceptable error range for the particular value as determined by one of ordinary skill in the art, which will depend in part on how the value is measured or determined, i.e., the limitations of the measurement system. For example, “about” can mean a range of up to 10% of a given value. Also, particularly with respect to systems or processes, the term can mean within an order of magnitude, preferably within two-fold of a value.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 as well as all intervening decimal values between the aforementioned integers such as, for example, 1.1, 1.2, 1.3, 1.4, 1.5, 1.6, 1.7, 1.8, and 1.9. Ranges disclosed herein, for example, “between about X and about Y” are, unless specified otherwise, inclusive of range limits about X and about Y as well as X and Y. With respect to sub-ranges, “nested sub-ranges” that extend from either endpoint of the range are specifically contemplated. For example, a nested sub-range of an exemplary range of 1 to 50 can include 1 to 10, 1 to 20, 1 to 30, and 1 to 40 in one direction, or 50 to 40, 50 to 30, 50 to 20, and 50 to 10 in the other direction.

In the detailed description herein, references to “embodiment,” “an embodiment,” “one embodiment”, “another embodiment,” “in various embodiments,” “certain embodiments,” etc., indicate that the embodiment(s) described can include a particular feature, structure, or characteristic, but every embodiment might not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

As used herein, the expression “adverse food reaction” is referring to an abnormal or exaggerated immune response of a companion animal to the ingestion of a food composition, which negative response can cause a reduced appetite that could lead to a refusal of the diet or a food aversion. An adverse food reaction response can be immune-mediated which is referred to as a food allergy. The said negative response can also be a non-immune-mediated response, called a food intolerance. Illustratively, an adverse food reaction encompasses pruritus, often referred as to itching, and can result in additional dermatological signs, such as alopecia, seborrhoea or pyoderma.

As used herein, the term “allergic reaction” or “allergy” is a clinical altered immune response by an individual to a dietary allergen. Symptoms of allergic reactions can affect the cutaneous (e.g., urticaria, angioedema, pruritus), respiratory (e.g., wheezing, coughing, laryngeal edema, rhinorrhea, watery/itching eyes), gastrointestinal (e.g., vomiting, abdominal pain, diarrhea), and/or cardiovascular (if a systemic reaction occurs) systems. Allergic reaction to a food composition can provoke an adverse food reaction by the companion animal feeding this food compositions.

In the context of the present disclosure, the term “food aversion” refers to an eating disorder in a companion animal that leads to detrimental health outcomes, including renal impairment, nutritional deficiencies, non-optimal puppy development or energy deficits. Food aversion manifests as adverse effects in companion animals, often stemming from a negative association between the taste of a particular food composition and symptoms induced by intoxication, spoilage, or toxic substances. Typically, a food aversion is developed by a companion animal following the ingestion of food compositions that elicit feelings of nausea, induce vomiting or induce an adverse food reaction.

As used herein, the terms “animal”, “companion animal”, or “pet” refers to domestic animals including, but not limited to, domestic dogs, domestic cats, horses, cows, ferrets, rabbits, pigs, rats, mice, gerbils, hamsters, goats, and the like. Domestic dogs and cats are particular non-limiting examples of pets. In a more specific embodiment, the term “companion animal” refers to pets, in particular dog and cat, particularly to puppy and kitten, and more particularly to puppy. As used herein, a “puppy” refers to a young dog aged from about 2 to about 15 months old, depending on the breed and expected adult weight. In some preferred embodiments, a puppy can be less than about 6 months old.

As used herein, the terms “food”, “food composition”, “diet” or “foodstuff” cover all of foodstuff, diet, food or a material that can contain proteins, carbohydrates and/or crude fats, which is used in the body of an organism to sustain growth, repair and vital processes and to furnish energy. Foods can also contain supplementary substances or additives, for example, minerals, vitamins and condiments (See Merriam-Webster's Collegiate

Dictionary, 10th Edition, 1993). Such food compositions can be nutritionally complete. In a particular embodiment, a food composition according to the present disclosure is a nutritionally complete food composition.

As used herein, “threonine” refers to an amino acid. An amino acid threonine can be used in the biosynthesis of proteins (CAS Registry Number® is 80-68-2). Threonine (Thr) is an essential amino acid needs to be present in the diet of companion animals, such as puppies. This essential amino acid is naturally present in protein source and can be added as a protein supplement in the formulation of the food compositions in order to achieve the target recommended level of threonine suitable for an optimal puppy's growth.

The term “carbohydrate” includes, for example without limitation, cereals, grains, corn, wheat, rice, oats, corn grits, sorghum, grain sorghum (milo), wheat bran, oat bran, amaranth, durum, semolina, or mixtures thereof.

The term “nitrogen-free extract (NFE)” represents the soluble carbohydrates, such as starch and sugar, of an animal food.

As used herein, the term “fat” encompasses any food-acceptable fat(s) and/or oil(s) irrespective of their consistency at room temperature, i.e., irrespective of whether said “fat” is present in essentially fluid form or in essentially solid form. In some embodiments, the term “fat” includes vegetal fat and/or animal fat. Fat can be supplied by any of a variety of sources known by those skilled in the art. SFat content of foods can be determined by any number of methods known by those of skill in the art. A fat source can comprise, or even consist essentially of a mixture of fatty acids.

As used herein, the terms “fat”, “oil”, and “lipid” are synonymous and also encompass mixtures of fats or oils. Animal fats as well as vegetable oils and/or marine oils can be used. Any commercially available source of animal, vegetable, marine fat can be tested. Plant oils are typically canola oil, soybean oil, corn oil, olive oil, sunflower oil, linseed oil, peanut oil, palm oil, palm kernel oil, safflower oil, rapeseed oil, cottonseed oil, coconut oil, and the like. Typical animal fats are beef fat (including beef tallow), pork fat (including pork lard), poultry fat (including chicken fat, turkey fat, duck fat, and combinations thereof), and the like. Marine oils are typically tuna oil, sardine oil, salmon oil, menhaden oil, anchovy oil, fish oil, and the like. Also are encompassed herein fats that are derived from animal, plant, marine sources, or that are produced by animals and plants.

As used herein, the term “dry food composition” generally refers to a food composition having a moisture content of less than 12% by weight, relative to the total weight of the food composition, and commonly even less than 7% by weight, relative to the total weight of the food composition. Dry food compositions can be formed by an extrusion process. In some embodiments, a dry food composition can be formed from a core and a coating to form a dry food composition that is coated, also called a coated dry animal food composition. It should be understood that when the term “dry food composition” is used, it can refer to an uncoated dry food composition or a coated dry food composition. A dry food composition can be a kibble.

As used herein, the term “kibble” includes a particulate pellet like component of animal feeds, such as dog and cat feeds, typically having a moisture, or water, content of less than 12% by weight, relative to the total weight of the kibble. Kibbles can range in texture from hard to soft. Kibbles can range in internal structure from expanded to dense.

As used herein “hypoallergenic food composition” as used herein refers to a composition for which a substantially limited or no allergic reaction is achieved upon consumption of the composition. Hypoallergenic food compositions disclosed herein can be dry or wet food compositions. In particular, hypoallergenic food compositions can be dry food compositions.

In the present disclosure, the expressions “hypoallergenic nutritionally complete dry food composition”, “food composition” and “composition” are alternatively used to designate the hypoallergenic nutritionally complete dry food composition of the present disclosure.

As used herein, the term “nutritionally complete” or “nutritionally balanced” means that the composition of the present disclosure provides the complete and balanced nutritional requirement to a companion animal. Specifically, a nutritionally complete food composition contains all known required nutrients for the intended recipient of the food composition, in all appropriate amounts and proportions based, for example, on recommendations of recognized and competent authorities in the field of animal nutrition. In certain embodiments such companion animals are puppies. Therefore, a nutritionally adequate feed is a feed with which the said companion animal, e.g., the said puppy, can be fed as the sole ration and is capable of sustaining life without additional food (except water). The nutritionally complete food composition can contain a carrier, a diluent, or an excipient. Depending on the intended use, the carrier, diluent, or excipient can be chosen to be suitable for animal use.

As used herein the term “optimal” in the context of growth or development refers to a food composition or formula providing complete and balance nutrition for a companion animal, such as a puppy. “Optimal” refers to an appropriate amount of calories supporting the growth and development of a companion animal throughout its life. This is defined as the amount that supports normal growth and maintains the puppy at a balanced lean body condition. The food composition of the present disclosure presents the right balance of protein, calcium, essential vitamins and minerals delivering the energy and vitality needed for supporting growth and development. Fast and low growth is not optimal growth. The optimal growth of a companion animal can be evaluated with the ratio of the weight and the age of the companion animal. In particular, the optimal growth also depends on the breed of the companion animal. The optimal growth of a companion animal can be evaluated by any suitable method known in the art. For instance, the growth can be objectively observed as regard of the line body of the companion animal or evaluated by management tools. Illustratively, the body condition score (BCS) can be used to evaluate body fat of dogs and cats (Body Condition Scores by Lynn Buzhardt, DVM Care & Wellness, Pet Services; or Baldwin et al. Journal of the American Animal Hospital Association, July/August 2010, Vol. 46).

As used herein, the terms “palatability” or “palatable” refer to being desirable to the palate or taste. Further, the terms “palatability” or “palatable” as used herein refer to the extent to which an animal food product, in particular a pet food product, appeals to the palate or taste of the animal. This is suitable measured by feeding tests, e.g., difference tests or ranking tests. In certain embodiments, “palatability” can mean a relative preference for one food product over another. For example, when an animal shows a preference for one of two or more food products, the preferred food product is more “palatable”, and has “enhanced palatability” or “increased palatability”.

Within the scope of the present disclosure, a reference optimal growth for a companion animal can be obtained by measuring the Body Score Condition (BCS).

For a dog on a 9-scale, a BCS from about 1 to less than 4, in particular would be indicative of an underweight. A BCS from 4 to 5, in particular 4, 4.5, or 5 would be indicative of an ideal weight for a dog. And a BCS from above 5 to 9, in particular 5, 5.5, 6, 6.5, 7, 7.5, 8, 8.5, or 9 would be indicative of an overweight for a dog.

A BCS of about 4 to 5 is targeted in a canine companion animal to achieve optimal growth and development and avoid nutritional related diseases in adulthood. In particular, a BCS of 4 to 5 throughout the life of the companion animal is optimal.

For a cat on a 5-scale, a BCS from about 1 to less than 2.5, would be indicative of an underweight. A BCS from 2.5 to 3.5 would be indicative of an ideal weight for a cat. And a BCS from above 3.5 to 5 would be indicative of an overweight for a cat. A BCS of 2.5 to 3.5 is targeted in feline companion animal to achieve optimal growth and development and avoid nutritional related diseases in adulthood.

In complement, a reference optimal growth for a companion animal can be obtained by measuring the muscle condition score (MCS). The MCS differs from the BCS in that the MCS evaluates muscle mass. Evaluation of muscle mass includes visual examination and palpation over the temporal bones, scapulae, lumbar vertebrae and pelvic bones.

The term “ppm” or “parts per million” is herein used according to its conventional meaning. More precisely, it refers herein to a weight amount relative to the total weight of the dry matter of the food composition (e.g., mg/kg) (unless otherwise indicated).

### Units

All weight percentages expressed herein are by weight of the total weight of dry matter of the food composition unless expressed otherwise.

As used herein, an amount of a component as expressed as weight/Mcal can consist of a weight amount of the said component by unit of Metabolizable Energy (ME) of the total animal food composition.

As used herein, the ME parameter is intended to represent the energy value of a food composition that is directly metabolized after consumption. Within the scope of the present disclosure, the ME value can be measured by any suitable method known in the art.

Illustratively, the ME value can be measured using feeding trial. In practice, the gross energy (GE) of the food is determined in the laboratory, and the amounts of food eaten by the animals are recorded. The feces and urine from the animals are collected, and the energy in each is determined and called fecal energy (FE) and urinary energy (UE), respectively. The ME is then calculated by the following formula:

ME(kcal/kg)=[GE−(FE+UE)]/Kg of food consumed.

Alternatively, the ME value can be measured by a mathematical method, in particular taking into account the percentage of crude fat (CF), the percentage of crude protein (CP), and the percentage of carbohydrates (NFE) in the composition. In practice each percentage is multiplied by its respective Atwater Factors. The resulting sum is then multiplied by 10. The mathematical method can be represented by the following formula:

ME(kcal/kg)=10×[(3.5×CP)+(8.5×CF)+(3.5×NFE)].

Metabolizable Energy is conventionally determinable according to standard methods, and especially according to the modified Atwater factorial equation proposed by the National Research Council (NRC) in 2006 (Calvez et al., PLOS One. 2019).

### 2. HYPOALLERGENIC NUTRITIONALLY COMPLETE DRY FOOD COMPOSITION

A hypoallergenic nutritionally complete dry food composition of the present disclosure shows advantages in promoting and supporting the growth of a companion animal, in particular a puppy, especially for a companion animal suffering from adverse food reaction.

The present disclosure relates to a hypoallergenic nutritionally complete dry food composition for a companion animal, preferably a puppy, wherein said composition can include: about 20% to about 25% by weight of vegetal proteins, said vegetal proteins having at least about 95% by weight of hydrolyzed vegetal proteins; about 15% to about 25% by weight of fat; about 200 ppm to about 500 ppm of vitamin C; about 400 ppm to about 900 ppm by weight of vitamin E, about 0.5% to about 2% by weight of calcium (Ca); about 0.5% to about 1.5% by weight of phosphorus (P); and about 0.5% to about 1.5% by weight of threonine (Thr), the weight percentage and ppm by being expressed on a dry matter basis.

Indeed, the said hypoallergenic nutritionally complete dry food composition can comprise other substances (such as fiber, lutein, taurine, beta-carotene, natural flavor(s), etc.) so that its composition amounts to 100% by weight on a dry matter basis.

The food composition according to the present disclosure is prepared according to the techniques which are well known to a person skilled in the art.

The palatability of the hypoallergenic palatable compositions according to the present disclosure can be measured by any suitable known method in the art. For example, the palatability of a food composition can be assessed using a single bowl test or a by a two-bowl test or other methods for determining palatability (Aldrich et al. Animals (Basel). 2015 Jan. 16; 5 (1): 43-55).

The hydrolyzed protein content of the composition ensures a decrease immune-system recognition and avoids food allergy.

### 2.1 Vegetal Proteins/Hydrolyzed Vegetal Proteins

A hypoallergenic nutritionally complete dry food composition according to the present disclosure can contain vegetal proteins from one or more distinct source(s) of proteins. Generally, a hypoallergenic nutritionally complete dry food composition as described herein can include a plurality of sources of vegetal proteins.

Without wishing to be bound by any particular theory, it is believed that vegetal proteins can cause less allergic reaction than animal proteins in a companion animal, while providing suitable protein nutriment for the companion animal to maintain its weight and/or for promoting and/or supporting the growth of the animal. In particular, it is believed that hydrolyzed vegetal proteins can cause at most a limited allergic reaction or even no allergic reaction in a companion animal, especially in a puppy.

In some embodiments, a hypoallergenic nutritionally complete dry food composition according to the present disclosure can include vegetal proteins in a range of from about 20% to about 25% by weight on a dry matter basis, said vegetal proteins comprising at least about 95% by weight of hydrolyzed vegetal proteins.

As used herein, a protein content ranging from about 20% to about 25% by weight includes a vegetal protein content of 21%, 22%, 23% and 24%, by weight, based on the total weight of dry matter of the food composition.

The expression “95% by weight of hydrolyzed vegetal proteins” is intended to refer to the percentage of hydrolyzed vegetal proteins by weight, based on the total weight of proteins of the food composition.

As used herein, the expression “at least about 95% by weight of hydrolyzed vegetal proteins” can include about 96%, 97%, 98%, 99% and 100% of hydrolyzed proteins, by weight, based on the total weight of proteins of the food composition.

In some embodiments, the vegetal proteins can include at least about 99% by weight of hydrolyzed vegetal proteins.

The hydrolyzed vegetal proteins contained in the food composition as described herein can be prepared according to the techniques which are well known to a person skilled in the art.

In some embodiments, the hydrolyzed vegetal proteins have a molecular weight of about 30,000 Dalton (Da) or less. This means that the hydrolyzed vegetal protein material contains peptides of a molecular weight of about 30,000 Da or less.

In some particular embodiments, the hydrolyzed vegetal proteins have a molecular weight of about 75 Da or more. This means that the hydrolyzed vegetal protein material contains peptides of a molecular weight of about 75 Da or more. Illustratively, a peptide of about 75 Da contained in the hydrolyzed vegetal proteins can consist of an amino acid.

As used herein, a peptide of about 75 Da or more encompasses peptides having a molecular weight of about 100 Da or more, 150 Da or more, 200 Da or more, 300 Da or more, 350 Da or more, 400 Da or more, 450 Da or more, 500 Da or more, 1,000 Da or more, 1,500 Da or more, 2,000 Da or more, 2,500 Da or more, 3,000 Da or more, 3,500 Da or more, 4,000 Da or more, 4,500 Da or more, 5,000 Da or more, 5,500 Da or more, 6,000 Da or more, 6,500 Da or more, 7,000 Da or more, 7,500 Da or more, 8,000 Da or more, 8,500 Da or more, 9,000 Da or more, 9,500 Da or more, 10,000 Da or more, 10,500 Da or more, 11,000 Da or more, 11,500 Da or more, 12,000 Da or more, 12,500 Da or more, 13,000 Da or more, 13,500 Da or more, 14,000 Da or more, 14,500 Da or more, 15,000 Da or more, 15,500 Da or more, 16,000 Da or more, 16,500 Da or more, 17,000 Da or more, 17,500 Da or more, 18,000 Da or more, 18,500 Da or more, 19,000 Da or more, 19,500 Da or more, 20,000 Da or more, 20,500 Da or more, 21,000 Da or more, 21,500 Da or more, 22,000 Da or more, 22,500 Da or more, 23,000 Da or more, 23,500 Da or more, 24,000 Da or more, 24,500 Da or more, 25,000 Da or more, 25,500 Da or more, 26,000 Da or more, 26,500 Da or more, 27,000 Da or more, 27,500 Da or more, 28,000 Da or more, 28,500 Da or more, 29,000 Da or more, 29,500 Da or more.

A peptide having a molecular weight of about 75 Da or more does not exceed a molecular weight of about 30,000 Da.

In some embodiments, the hydrolyzed vegetal proteins can have a molecular weight ranging from about 75 Da to about 30,000 Da.

In some embodiments, the hydrolyzed vegetal proteins can have a molecular weight ranging from about 75 Da to about 20,000 Da.

In some embodiments, the hydrolyzed vegetal proteins can have a molecular weight ranging from about 75 Da to about 10,000 Da.

In some embodiments, the hydrolyzed vegetal proteins can have a molecular weight ranging from about 75 Da to about 5,000 Da.

In some embodiments, the hydrolyzed vegetal proteins can be from vegetal origin, in particular from wheat, soy, rice, corn and pea.

In some embodiments, the source of partially hydrolyzed proteins can be selected from soya, rice, and/or a combination thereof.

A hypoallergenic nutritionally complete dry food composition as described herein can include proteins and more particularly amino acids, such that the amino acid profile is adequate to support growth.

As a non-limitative example, a hypoallergenic nutritionally complete dry food composition as described herein can include from about 0.5% by weight to about 1.5% by weight of threonine.

According to some embodiments, the source of threonine is not limiting. In some embodiments, threonine can be naturally contained in protein sources such as chicken, turkey, beef, fish, eggs, or vegetal-based proteins. In certain embodiments, threonine can be provided by the hydrolyzed vegetal proteins, in particular from wheat, soy, rice, corn and pea.

In some embodiments, a source of threonine can be a protein supplement comprising at least threonine and, optionally, one or more other amino acid(s). In some embodiments, a source of threonine can be a threonine supplement. A protein supplement comprising threonine can be available commercially and/or produced by bacterial engineering.

The content of threonine of the food composition can be determined by any suitable methods known in the art. To determine that the animal food composition contains the right balance of amino acids, including threonine, the amino acid profiles of the ingredients can be determined. For instance, the content of threonine can be evaluated by the methods disclosed by Fauconneau, INRA/EDP Sciences, 1956, or Rutherfurd et al., Curr Protoc Protein Sci. 2009.

In some embodiments, the threonine content of the food composition according to the present disclosure can range from about 0.5% to about 1.5% by weight of threonine, based on the total weight of dry matter of the food composition.

As used herein, about 0.5% to about 1.5% by weight of threonine can include about 0.6%, 0.7%, 0.8%, 0.9%, 1.0%, 1.1%, 1.2%, 1.3% and 1.4% by weight of threonine based on the total weight of dry matter of the food composition.

In some embodiments, threonine can be introduced into the food composition formula through the inclusion of a raw material as a protein source. Depending upon the formula, the proportion of raw material used as a protein source can vary to meet the target range of about 0.5% by weight to about 1.5% by weight of threonine while meeting the proportion of other components such as overall protein amount, fat, fibre etc. Consequently, depending on the particular food composition formula, the addition of a protein supplement containing threonine can be necessary to achieve the desired threonine content in the final food composition. Illustratively, threonine can be incorporated through raw materials, such as vegetal-based proteins, in a total amount of 0.1% by weight on a dry matter basis. Therefore, a protein supplement should be incorporated to attain the desired content of threonine, ranging from about 0.5% by weight to about 1.5% by weight of threonine, on a dry matter basis.

In some embodiments, a protein supplement can be introduced in the food composition of the present disclosure, to attain the desired content of threonine, in an amount ranging from about 0.01% by weight to about 1.5% by weigh of threonine, based on the total weight of dry matter of the food composition. In some embodiments, a protein supplement can be introduced in the food composition of the present disclosure, to attain the desired content of threonine, in an amount of about 0.01%, about 0.05%, about 0.1%, about 0.15%, about 0.20%,.about 0.25%, about 0.30%, about 0.35%, about 0.40%, about 0.45%, about 0.50%, about 0.55%, about 0.60%, about 0.65%, about 0.70%, about 0.75%, about 0.80%, about 0.85%, about 0.90%, about 0.95%, about 1.0% or about 1.5% by weight of threonine, based on the total weight of dry matter of the food composition.

### 2.2 Fat

A hypoallergenic nutritionally complete dry food composition according to the present disclosure can include a nutritionally appropriate amount of fat.

As used herein, the expression “source of fat” is intended to refer to any food-acceptable fat and/or oil. The fat in accordance with the present disclosure can be indifferently in a fluid form and/or in a solid form.

In some embodiments, the hypoallergenic nutritionally complete dry food composition as described herein can include fat from animal origin and/or from vegetal origin. Fat can be supplied by any suitable source known by those skilled in the art.

In some embodiments, the hypoallergenic nutritionally complete dry food composition as described herein can include fat originate from a vegetal source or an animal source.

In some embodiments, a fat source can be a vegetal fat source. In some embodiments, a fat source can be an animal fat source. In some embodiments, a fat source can include a vegetal fat and animal fat.

A suitable vegetal fat source can include, without limitation, wheat, sunflower, safflower, rapeseed, olive, borage, flaxseed, peanuts, blackcurrant seed, cottonseed, germ, corn germ, algae, and/or a combination thereof as well as oils derived from these.

A suitable animal fat source can include, for example and without limitation, meat; meat by-products such as chicken fat, turkey fat, beef fat, duck fat, pork fat, lamb fat; fish oil, seafood; dairy; eggs.

In some embodiments, the animal fat source can be selected from fish oil, algae oil, krill oil, and/or a combination thereof.

In some embodiments, a weight ratio of vegetal fat to animal fat can range from about 1:1 to about 2:1.

In some embodiments, the fat content in a hypoallergenic nutritionally complete dry food composition as described herein ranges from about 15% to about 25% by weight of fat based on the total weight of dry matter of the food composition.

As used herein, from about 15% to about 25% by weight of fat includes 16%, 17%, 18%, 19%, 20%, 21%, 22%, 23%, 24% by weight of fat, based on the total weight of dry matter of the composition.

Illustratively, the fat content can include a source of linoleic acid, alpha-linoleic acid, arachidonic acid, omega-6 fatty acids, omega-3 fatty acids, eicosapentaenoic acid (EPA), docosahexaenoic acid (DHA) and a mixture thereof.

Within the purpose of the present disclosure, the EPA and/or DHA and linoleic acid content can generate an anti-inflammatory effect, in particular a decrease skin inflammation.

### 2.3 Vitamin C

A hypoallergenic nutritionally complete dry food composition as described herein can include vitamin C from one or more distinct source(s) of vitamin C.

Vitamin C, also known as ascorbic acid, is an essential nutrient involved in the repair of tissue and in immune system function. Vitamin C cannot be synthesized in vivo.

Vitamin C can be a natural or a synthetic nutrient which can be provided from a plurality of sources. Vitamin C can be obtained from whole food sources or artificially obtained with an industrial process, thereby obtaining isolated nutrients.

In certain embodiments, vitamin C can be provided from a natural source, in particular a plant source. A suitable plant source of vitamin C can include, without limitation, Kakadu plum, camu camu, acerola, seabuckthorn, Indian gooseberry, rose hip, guava, blackcurrant, yellow bell pepper, red bell pepper, green beel pepper, kale, kiwi, broccoli, loganberry, cloudberry, elderberry, papaya, strawberry, orange, lemon, pineapple, cauliflower, cantaloupe, grapefruit, raspberry, passion fruit, spinach, cabbage, mango and blackberry.

In some embodiments, vitamin C can be provided as an isolated nutrient. Vitamin C in an isolated nutrient form can be obtained from a concentrated/dehydrated whole food.

In some embodiments, the vitamin C content in the composition according to the present disclosure can range from about 200 ppm to about 500 ppm by weight of vitamin C, based on the total weight of dry matter of the food composition.

As used herein, about 200 ppm to about 500 ppm of vitamin C includes about 200 ppm, 210 ppm, 220 ppm, 230 ppm, 240 ppm, 250 ppm, 260 ppm, 270 ppm, 280 ppm, 290 ppm, 300 ppm, 310 ppm, 320 ppm, 330 ppm, 340 ppm, 350 ppm, 360 ppm, 370 ppm, 380 ppm, 390 ppm, 400 ppm, 410 ppm, 420 ppm, 430 ppm, 450 ppm, 460 ppm, 470 ppm, 480 ppm, 490 ppm and 500 ppm by weight of vitamin C based on the total weight of dry matter of the food composition.

In some embodiments, the vitamin C content in the composition according to the present disclosure can range from about 350 ppm to about 450 ppm by weight of vitamin C, based on the total weight of dry matter of the food composition.

In some embodiments, the vitamin C content within the composition can be of about 400 ppm by weight, based on a dry matter basis.

Vitamin C according to the present disclosure refers to the CAS Registry Number® 50-81-7 and to a compound of the following structure:

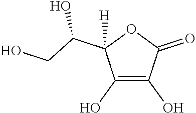 [SMILES: O=C1O[C@H]([C@@H](O)CO)C(O)=C1O]

or one of its pharmaceutically acceptable salts and/or racemic, enantiomeric, diastereoisomeric or tautomeric forms.

### 2.4 Vitamin E

A hypoallergenic nutritionally complete dry food composition as described herein can include vitamin E from one or more distinct source(s) of vitamin E.

Vitamin E includes tocopherols and tocotrienols, which share the same biological activity. The most biologically active biological form of vitamin E (also the most active antioxidant) in animal tissue is alpha-tocopherol. Vitamin E cannot be synthesized in vivo.

Vitamin E according to an aspect of the present disclosure can be in any form. Vitamin E can be liquid, semi-solid or solid. Vitamin E can be tocopherol or tocotrienol. Vitamin E can be alphatocopherol, (d-x or dl-oc) beta-tocopherol (d-,B or dl-), gamma-tocopherol (dot or dim), delta-tocopherol, alpha-tocotrienol, beta-tocotrienol, gamma-tocotrienol or delta-tocotrienol. In certain particular embodiments, vitamin E can be alpha-tocopherol.

Vitamin E can be provided from a plurality of source. In certain embodiments, a source of vitamin E can include vitamin E acetate, (e.g., tocopherol acetate), vitamin E acetate adsorbate or vitamin E acetate spray dried. In certain particular embodiments, vitamin E can be produced either by extraction, or by synthesis, or biotechnologically.

In some embodiments, vitamin E content in a composition according to the present disclosure can range from about 400 ppm to about 900 ppm by weight of vitamin E, based on the total weight of dry matter of the food composition.

As used herein, about 400 ppm to about 900 ppm by weight of vitamin E includes about 400 ppm, 410 ppm, 420 ppm, 430 ppm, 440 ppm, 450 ppm, 460 ppm, 470 ppm, 480 ppm, 490 ppm, 500 ppm, 510 ppm, 520 ppm, 530 ppm, 550 ppm, 560 ppm, 570 ppm, 580 ppm and 590 ppm, 600 ppm, 610 ppm, 620 ppm, 630 ppm, 640 ppm, 650 ppm, 660 ppm, 670 ppm, 680 ppm, 690 ppm, 700 ppm, 710 ppm, 720 ppm, 730 ppm 740 ppm, 750 ppm, 760 ppm, 770 ppm, 780 ppm, 790 ppm, 800 ppm, 810 ppm, 820 ppm, 830 ppm, 840 ppm, 850 ppm, 860 ppm, 870 ppm, 880 ppm, 890 ppm and 900 ppm by weight of vitamin E, based on the total weight of dry matter of the food composition.

In some embodiments, vitamin E content in a composition according to the present disclosure can range from about 600 ppm to about 800 ppm by weight of vitamin E, based on the total weight of dry matter of the food composition.

In some embodiments, the vitamin E content within the composition can be of about 700 ppm by weight, based on a dry matter basis.

Vitamin E according to the present disclosure refers to a compound of the following structure:

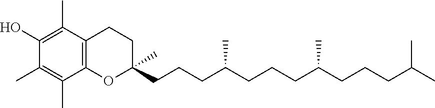 [SMILES: Cc1c(C)c2c(c(C)c1O)CC[C@@](C)(CCC[C@H](C)CCC[C@H](C)CCCC(C)C)O2]

or one of its pharmaceutically acceptable salts and/or racemic, enantiomeric, diastereoisomeric or tautomeric forms.

### 2.5 Calcium

A hypoallergenic nutritionally complete dry food composition as described herein can include calcium from one or more distinct source(s) of calcium.

As used herein the term “calcium” refers to its general meaning in the field and refers to a chemical element, with the symbol “Ca” and atomic number 20, present in nature and in the human body, where it is essential for bone strength and the functioning of muscle and nerve cells.

Calcium can be prided from a plurality of source. In certain embodiments, a source of calcium can include milk, sardines, salmon, soy, kale and cereals.

In certain particular embodiments, calcium can be provided in an isolated nutrient form. In some embodiments, calcium in an isolated nutrient from can be produced either by extraction from a concentrated/dehydrated whole food, or by synthesis, or by biotechnologically.

In some embodiments, the calcium content in a composition according to the present disclosure can range from about 0.5% to about 2% by weight of calcium, based on the total weight of dry matter of the composition.

As used herein, about 0.5% to about 2% by weight of calcium includes about 0.6%, 0.7%, 0.8%, 0.9%, 1.0%, 1.1%, 1.2%, 1.3%, 1.4%, 1.5%, 1.6%, 1.7%, 1.8% and 1.9% by weight of calcium, based on the total weight of dry matter of the composition.

### 2.6 Phosphorus

A hypoallergenic nutritionally complete dry food composition as described herein can include phosphorus from one or more distinct source(s) of phosphorus.

As used herein the term “phosphorus” refers to its general meaning in the field and refers to a chemical element, with the symbol “P” and atomic number 15. Phosphorus exists in two forms, white phosphorus and red phosphorus.

According to one embodiment, the source of phosphorus is not limiting. In certain embodiments, phosphorus sources include milk, meat, and soya.

In some embodiments, phosphorus can be produced either by extraction from a concentrated whole food, or by synthesis, or by biotechnologically.

In some embodiments, the phosphorus content in the composition according to the present disclosure can range from about 0.5% to about 1.5% by weight of phosphorus, based on the total weight of dry matter of the composition.

As used herein, about 0.5% to about 1.5% by weight of phosphorus includes about 0.6%, 0.7%, 0.8%, 0.9%, 1.0%, 1.1%, 1.2%, 1.3% and 1.4% by weight of phosphorus, based on the total weight of dry matter of the composition.

### 2.7 Fibers

Fibers, from one or more distinct source(s) of fibers, are optionally present in a hypoallergenic nutritionally complete dry food compositions as disclosed herein.

The term “fibers” is used herein similarly to “dietary fibers” and shall be interpreted for the purpose of the present disclosure as Total Fibers, meaning that it includes soluble fibers and insoluble fibers.

In some embodiments, fibers can include soluble and insoluble fibers.

Soluble fiber, as used herein, refers to a fiber that is resistant to digestion and absorption in the small intestine and undergo complete or partial fermentation in the large intestine. Soluble fibers are considered as having a prebiotic effect by providing short chain fatty acids as a source of energy to colonocytes.

In contrast, insoluble fibers are considered as useful for transit and ballast effect. In some embodiments, weight ratio of soluble fibers to insoluble fibers can ranges from about 1:2 to about 1:1.

In some embodiments, a hypoallergenic nutritionally complete dry food composition as described herein can include an amount ranging from about 2% by weight to about 20% by weight of fibers, based on the total weight of dry matter of the composition.

As used herein, from about 2% by weight to about 20% by weight of total dietary fibers includes about 2%, 3%, 4%, 5%, 6%, 7%, 8%, 9%, 10%, 11%, 12%, 13%, 14%, 15%, 16%, 17%, 18%, 19% and 20% by weight of fibers, based on the total weight of dry matter of the composition.

In some embodiments, a hypoallergenic nutritionally complete dry food composition as described herein can include an amount of about 5%, 5.1%, 5.2%, 5.3%, 5.4%, 5.5%, 5.6%, 5.7%, 5.8% or 5.9% by weight of fibers, based on the total weight of dry matter of the composition.

In some embodiments, a source of soluble fiber can be selected from beet pulp, guar gum, chicory pulp, chicory root, psyllium, pectin, blueberry, cranberry, squash, apples, oats, beans, citrus, barley, peas, and/or a combination thereof.

In some embodiments, a source of insoluble fiber can be selected from cellulose, whole wheat products, wheat oat, corn bran, flax seed, grapes, celery, green beans, cauliflower, potato skins, fruit skins, vegetable skins, peanut hulls, soy fiber, and/or a combination thereof.

### 2.8 Lutein

In certain embodiments, the hypoallergenic nutritionally complete dry food composition as described herein can include lutein from one or more distinct source(s) of lutein.

As used herein, “lutein” refers to a xanthophyll and one of known naturally occurring carotenoids. Lutein is a lipophilic molecule and is generally insoluble in water. Lutein is synthesized only by plants and like other xanthophylls is found in high quantities in green leafy vegetables such as spinach, kale and yellow carrots. Lutein is isomeric with zeaxanthin, differing only in the placement of one double bond. The principal natural stereoisomer of lutein is (3R,3′R,6′R)-beta, epsilon-carotene-3,3′-diol. Lutein is present in plants as fatty-acid esters, with one or two fatty acids bound to the two hydroxyl-groups.

Lutein according to the present disclosure refers to a compound of the following structure:

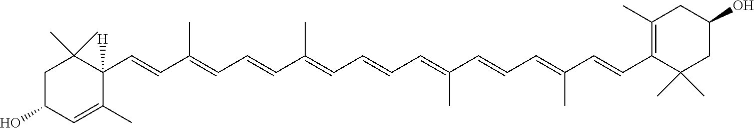 [SMILES: CC1=C[C@H](O)CC(C)(C)[C@H]1/C=C/C(C)=C/C=C/C(C)=C/C=C/C=C(C)/C=C/C=C(C)/C=C/C1=C(C)C[C@@H](O)CC1(C)C]

or one of its pharmaceutically acceptable salts and/or racemic, enantiomeric, diastereoisomeric or tautomeric forms.

In some embodiments, a hypoallergenic nutritionally complete dry food composition as disclosed herein can further include from about 3% to about 7% by weight of lutein, based on the total weight of dry matter of the composition.

In some embodiments, a hypoallergenic nutritionally complete dry food composition as disclosed herein can further include from about 4% to about 6% by weight of lutein, based on the total weight of dry matter of the composition.

In some embodiments, a hypoallergenic nutritionally complete dry food composition as disclosed herein can further include from about 4.8% to about 5.2% by weight of lutein, based on the total weight of dry matter of the composition.

As used herein, from about 3% to about 7% by weight of lutein includes about 3.2%, 3.5%, 3.8%, 4%, 4.2%, 4.5%, 4.8%, 5%, 5.2%, 5.5%, 5.8%, 6%, 6.2%, 6.5%, and 6.8% by weight of lutein, based on the total weight of dry matter of the composition.

According to one embodiment, the source of lutein is not limiting. In certain embodiments, lutein sources include kale, parsley, spinach, broccoli, peas, orange, honeydew melon, kiwis, red peppers, squash and grapes.

In some embodiments, lutein can be produced either by extraction from a concentrated whole food source, or by chemical synthesis, or by biological synthesis (e.g. by enzyme synthesis or by culturing lutein-producing cells, which includes by culturing lutein-producing genetically-engineered lutein-producing cells).

### 2.9 Taurine

In certain embodiments, the hypoallergenic nutritionally complete dry food composition as described herein can further include taurine.

Taurine is a non-essential amino acid which is obtained from meat and fish. It stimulates the production of glycosphingolipids in the skin by acting as a precursor molecule. Glycosphingolipids exhibit anti-microbial properties.

In certain embodiments, taurine refers to a compound of the following structure:

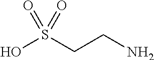

or one of its pharmaceutically acceptable salts and/or racemic, enantiomeric, diastereoisomeric or tautomeric forms.

In some embodiments, a hypoallergenic nutritionally complete dry food composition as disclosed herein can further include between about 0.1% to about 2% of taurine, based on the total weight of dry matter of the composition.

In some embodiments, a hypoallergenic nutritionally complete dry food composition as disclosed herein can further include from about 0.3% to about 1% by weight of taurine, based on the total weight of dry matter of the composition.

In some embodiments, a hypoallergenic nutritionally complete dry food composition as disclosed herein can further comprise from about 0.4% to about 0.6% by weight of taurine, based on the total weight of dry matter of the composition.

As used herein, from about 0.1% to about 2% by weight of lutein includes about 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8 and 1.9% by weight of lutein, based on the total weight of dry matter of the composition.

According to some embodiments, the source of taurine is not limiting. In certain embodiments, taurine sources include meats, milk and seaweed.

In some embodiments, taurine can be produced either by extraction from a concentrated whole food source, or by chemical synthesis, or biological synthesis (e.g. enzyme synthesis or by culturing taurine-producing cells, which includes by culturing lutein-producing genetically-engineered taurine-producing cells).

### 2.10 Beta-carotene

In certain embodiments, the hypoallergenic nutritionally complete dry food composition as described herein can further include beta-carotene.

The beta-carotene is one of the three carotenes (alpha-carotene, beta-carotene and lycopene). Beta-carotene molecule is a chain constituted of eight isoprene units with alternating single and double bonds, and has the formula:

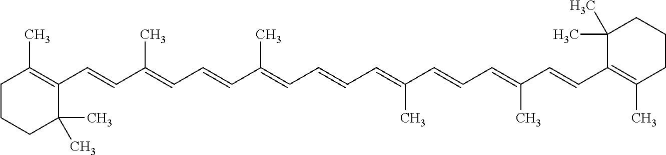 [SMILES: CC1=C(/C=C/C(C)=C/C=C/C(C)=C/C=C/C=C(C)/C=C/C=C(C)/C=C/C2=C(C)CCCC2(C)C)C(C)(C)CCC1]

Beta-carotene is found in certain fruits and vegetables such as pepper, carrot, spinach, lettuce, tomato, sweet potato, broccoli, cantaloupe, marrow, apricot. Beta-carotene can be produced either by extraction, or by synthesis, or biotechnologically. Natural beta-carotene comes mainly from alfalfa and red palm oil, and also carrot oil

In some embodiments, a hypoallergenic nutritionally complete dry food composition as disclosed herein can further include from about 1.5 ppm to about 10 ppm by weight of beta-carotene, particularly from about 2 ppm to about 7 ppm by weight of beta-carotene, and more particularly from about 4 ppm to about 5 ppm by weight of beta-carotene, based on the total weight of dry matter of the composition.

As used herein, about 1.5 ppm to about 10 ppm by weight of beta-carotene includes about 2 ppm, 2.5 ppm, 3 ppm, 3.5 ppm, 4 ppm, 4.5 ppm, 5 ppm, 5.5 ppm, 6 ppm, 6.5 ppm, 7 ppm, 7.5 ppm, 8 ppm, 8.5 ppm, 9 ppm and 9.5 ppm by weight of vitamin E, based on the total weight of dry matter of the food composition.

It should be noted that, every embodiment of a hypoallergenic nutritionally complete dry food composition encompassed by the present disclosure includes a variety of ingredients, each comprised in the said dry food composition at a given weight percentage, as compared to the total weight of dry matter of the dry food composition.

Mainly, a hypoallergenic nutritionally complete dry food composition as described herein includes protein, fat, vitamin C, vitamin E, calcium, phosphorus, and optionally one or more further ingredients such as vitamins, minerals, carbohydrates, NFE, ash, starch, preservatives etc., the sum of the weight of each of the ingredients comprised therein amounting to 100% by weight, based on the total weight of dry matter of the said dry food composition.

For instance, relating to a food composition on 100% of dry matter, 20% of the weight can be composed of hydrolyzed vegetal proteins, 15% of the weight can be composed of fibers, 400 ppm of the weight can be composed of vitamin C, 700 ppm of the weight can be composed of vitamin E, 0.5% of the weight can be composed of calcium, 0.5% of the weight can be composed of phosphorus and 0.5% of the weight can be composed of threonine, and the remaining ingredients can be composed of other ingredients, e.g., about 63% in the example.

It is well known by the skilled person in the art that a food can further include further nutrients such as carbohydrates, NFE, ash, preservatives, stabilizers, added salt, spices, seasonings, excipients, vitamins, minerals, flavorants, colorants, and the like.

Illustratively, when the total amount of nutrient of the food composition as described herein, in particular proteins, fat, vitamin C, vitamin E, phosphorus and threonine is of about 37% by weight, based on a dry matter basis, the amount of the other nutrients is of about 63% by weight to reach 100% of the total dry matter of the food composition.

The amount of such optional components is at least partially dependent on the nutritional requirements for different life stages of the companion animal.

In some embodiments, a hypoallergenic nutritionally complete dry food composition as disclosed herein can further include at least one natural flavor.

In some embodiments, the flavour can be provided from a source of protein.

Table 1 below provides an example of characterization of a hypoallergenic nutritionally complete dry food composition according to the disclosure, on the basis of dry matter, also referred to as % dry matter.

TABLE 1
Nutritional analysis of an illustrative embodiment of the nutrient
formulation of a hypoallergenic nutritionally complete dry
food composition according to the instant disclosure expressed
as percentage (%) and ppm on a dry matter basis.

| | Nutritional analysis |
|---|---|
| DM (%) | 90.5 |
| Protein (%) | 23.3 |
| Fat (%) | 19 |
| Vitamin C (ppm) | 400 |
| Vitamin E (ppm) | 700 |
| Ca (%) | 1.3 |
| P (%) | 1 |
| Thr (%) | 1 |
| Others | about 45.71 |
| Total | 100% |

Others: It can include, without limitation, Lutein, Taurine, beta-carotene, fibers, carbohydrates, minerals and vitamins.

Ingredients: Proteins can be hydrolyzed soy protein. Fat can be poultry and/or pork fat.

The moisture content (% w/w) represents the content of liquid, in particular of aqueous content, more particularly the water content of the composition.

In some embodiments, the moisture content of the composition according to the present disclosure ranges from about 4% to about 12% by weight, based on the total weight of the composition.

As used herein, from about 4% to about 12% by weight of moisture includes about 4.5%, 5.0%, 5.5%, 6.0%, 6.5%, 7.0%, 7.5%, 8.0%, 8.5%, 9.0%, 9.5%, 10.0%, 10.5%, 11.0% and 11.5% by weight of moisture, based on the total weight of the composition.

In some embodiments, a hypoallergenic nutritionally complete dry food composition as described herein can be in the form of a kibble, a snack, a treat or a biscuit.

In some embodiments, a hypoallergenic nutritionally complete dry food composition as disclosed herein can be a kibble.

In some embodiments, a dry food composition as disclosed, in particular a kibble, can have a size that does not exceed about 15 mm×15 mm×7 mm.

In some embodiments, a dry food composition as disclosed, in particular a kibble, can have a size that does not exceed about 14 mm×14 mm×6 mm.

In some embodiments, a dry food composition as disclosed, in particular a kibble, can have a size that does not exceed about 13 mm×13 mm×5 mm.

In some embodiments, a dry food composition as disclosed, in particular a kibble, can have a size that does not exceed about 12 mm×12 mm×4 mm.

In some embodiments, a dry food composition as disclosed, in particular a kibble, can have a size that does not exceed about 11 mm×11 mm×4 mm.

In some embodiments, a dry food composition as disclosed, in particular a kibble, can have a size that does not exceed about 10.5 mm×10.5 mm×4 mm.

In some embodiments, a dry food composition as disclosed, in particular a kibble, can have a size of about 10.5 mm or less ×10.5 mm or less ×4 mm or less.

In some embodiments, a dry food composition as disclosed, in particular a kibble, can have a size of about 10.5 mm×10.5 mm×4 mm.

Illustratively, as a non-limitative reference, a kibble intended to be fed to an adult companion animal, in particular which can have more than 15 months depending on the breed, can have a size of at least 15.2 mm×15 mm×7.5 mm.

In some embodiments, the food composition according to the present disclosure can also be characterized by its Metabolizable Energy (ME) parameter. All mentioned Metabolizable Energy are measured according to the NRC 2006.

In some embodiments, a hypoallergenic nutritionally complete dry food composition as disclosed herein can have a Metabolizable Energy (ME) of at least about 3,000 kcal/kg, as measured according to the NRC 2006.

In some embodiments, the Metabolizable Energy (ME) does not exceed about 5,000 kcal/kg.

In some embodiments, the Metabolizable Energy (ME) can be of from about 3,000 kcal/kg to about 5,000 kcal/kg.

In some embodiments, the Metabolizable Energy (ME) can be of about 3,000 kcal/kg, 3,100 kcal/kg, 3,200 kcal/kg, 3,300 kcal/kg, 3,400 kcal/kg, 3,500 kcal/kg, 3,600 kcal/kg, 3,700 kcal/kg, 3,800 kcal/kg, 3,900 kcal/kg, 4,000 kcal/kg, 4,100 kcal/kg, 4,200 kcal/kg, 4,300 kcal/kg, 4,400 kcal/kg, 4,500 kcal/kg, 4,600 kcal/kg, 4,700 kcal/kg, 4,800 kcal/kg, 4,900 kcal/kg or 5,000 kcal/kg.

In some embodiments, the dry food composition can have a ME of about 3,800 kcal/kg, 3,900 kcal/kg, 4,000 kcal/kg or 4,100 kcal/kg.

In some particular embodiments, the dry food composition can have a ME of about 4,000 kcal/kg, in particular 4,024 kcal/kg.

### 3. METHOD FOR MANUFACTURING HYPOALLERGENIC NUTRITIONALLY COMPLETE DRY FOOD COMPOSITIONS

In certain embodiments, a method for manufacturing a hypoallergenic nutritionally complete dry food composition as described herein is provided.

In certain embodiments, one or more dry ingredients can be mixed with one or more wet ingredients to form an emulsion or dough.

In certain embodiments, one or more dry ingredients can be mixed with one or more dry ingredients to form an emulsion or dough.

The emulsion or dough can be heated under pressure to a predetermined temperature and gradually cooled. Alternatively, an emulsion can be formed which can be comminuted and heated to a predetermined temperature, and subsequently introduced into a processing zone. In the processing zone, the emulsion can be subjected to a predetermined pressure and discharged.

In certain non-limiting embodiments, one or more dry ingredients can be mixed with one or more wet ingredients, for example, water, to form a dough. The dough can be cooked during extrusion under conditions of elevated temperature, pressure, or combination thereof. The extruder can be provided with a die having a particular shape and the extrudate can be segmented into particles or pieces as the product is extruded.

In another aspect, the disclosure can also relate to a method of manufacturing a hypoallergenic nutritionally complete dry food composition as described herein, including the step of:
a) mixing the ingredients of a hypoallergenic nutritionally complete dry food composition, thereby obtaining a mixture, and
b) heating the mixture, obtaining the hypoallergenic nutritionally complete dry food composition.

In some embodiments, the ingredients of a hypoallergenic nutritionally complete dry food composition as described herein collectively provide at least the following nutrients (i) vegetal proteins, (ii) fat, (iii) vitamin C, (iv) vitamin E, (v) calcium, (vi) phosphorus, and (vii) threonine, thereby obtaining a mixture.

In particular, the method for manufacturing a hypoallergenic nutritionally complete dry food composition as described herein can include at least a step of:
a) mixing at least (i) vegetal proteins, (ii) fat, (iii) vitamin C, (iv) vitamin E, (v) calcium, (vi) phosphorus, and (vii) threonine, thereby obtaining a mixture, and
b) heating the mixture and obtaining the hypoallergenic nutritionally complete dry food composition.

In particular, the method for manufacturing a hypoallergenic nutritionally complete dry food composition can include at least a step of mixing ingredients including (i) from about 20% to about 25% by weight of vegetal proteins, said vegetal proteins comprising at least about 95% by weight of hydrolyzed vegetal proteins, (ii) from about 15% to about 25% by weight of fat, (iii) from about 200 ppm to about 500 ppm by weight of vitamin C, (iv) from about 400 ppm to about 900 ppm by weight of vitamin E, (v) from about 0.5% to about 2% by weight of calcium, (vi) from about 0.5% to about 1.5% by weight of phosphorus, and (vii) from about 0.5% to about 1.5% by weight of threonine, the weight percentage and weight ppm being expressed on a dry matter basis.

The form of the ingredients used in the method of manufacturing are not limited to a particular form. Illustratively, a vegetal protein can be provided from a single source of vegetal proteins or a mix of at least two sources of vegetal proteins.

In particular, the method for manufacturing a hypoallergenic nutritionally complete dry food composition can include at least a step of:
a) mixing ingredients including (i) from about 20% to about 25% by weight of vegetal proteins, said vegetal proteins having at least about 95% by weight of hydrolyzed vegetal proteins, (ii) from about 15% to about 25% by weight of fat, (iii) from about 200 ppm to about 500 ppm of vitamin C, (iv) from about 400 ppm to about 900 ppm of vitamin E, (v) from about 0.5% to about 2% by weight of calcium, (vi) from about 0.5% to about 1.5% by weight of phosphorus, and (vii) from about 0.5% to about 1.5% by weight of threonine, thereby obtaining a mixture, the weight percentage and weight ppm being expressed on a dry matter basis; and
b) heating the mixture, obtaining the hypoallergenic nutritionally complete dry food composition.

In some embodiments, the method for manufacturing a hypoallergenic nutritionally complete dry food composition can include at least the steps of:
a) mixing ingredients to obtain a mixture including (i) from about 20% to about 25% by weight of vegetal proteins, said vegetal proteins having at least about 95% by weight of hydrolyzed vegetal proteins, (ii) from about 15% to about 25% by weight of fat, (iii) from about 200 ppm to about 500 ppm of vitamin C, (iv) from about 400 ppm to about 900 ppm of vitamin E, (v) from about 0.5% to about 2% by weight of calcium, (vi) from about 0.5% to about 1.5% by weight of phosphorus, (vii) from about 0.5% to about 1.5% by weight of threonine, and (viii) an amount of one or more further components so as reaching 100% by weight of the mixture, the weight percentage and weight ppm being expressed on a dry matter basis; and
b) heating the mixture, obtaining the hypoallergenic nutritionally complete dry food composition.

A person of ordinary skill in the art will appreciate a wide variety of methods of manufacturing hypoallergenic nutritionally complete dry food compositions are suitable for use with the present disclosure.

It is needless to mention that the combined ingredients of the hypoallergenic nutritionally complete dry food composition according to the disclosure provide all the recommended nutrients, vitamins, and minerals for a companion animal, preferably a puppy, to obtain a complete and balanced food.

In some embodiments, the food composition according to the present disclosure can comply with the recommendations provided by the National Research Council, in 2006 (Nutritional Requirements for dogs, National Academy Press, Washington DC) or by the Association of America Feed Control Officials (Official Publication 1996), preferably to comply with the AAFCO Growth recommendations.

### 4. USES OF HYPOALLERGENIC NUTRITIONALLY COMPLETE DRY FOOD COMPOSITIONS

According to another aspect, the disclosure relates to the use of a hypoallergenic nutritionally complete dry food composition as described herein for promoting and/or supporting the growth of a companion animal, preferably a puppy.

In some embodiments, the disclosure relates to a method for promoting and/or supporting the growth of a companion animal, preferably a puppy, including at least a step of providing a hypoallergenic nutritionally complete dry food composition as described herein to the said companion animal.

In some embodiments, the method can further include a step of feeding the said companion animal with the hypoallergenic nutritionally complete dry food composition.

In some embodiments, the companion animal, preferably the puppy, is affected with adverse food reaction.

In some embodiments, the disclosure relates to the use of a hypoallergenic nutritionally complete dry food composition as described herein for promoting and/or supporting the growth of a puppy affected with adverse food reaction.

Otherwise said, the hypoallergenic nutritionally complete dry food composition of the present disclosure can be used to provide to a companion animal an optimal development and growth.

In some embodiments, it is preferred to use the hypoallergenic nutritionally complete dry food composition on puppy affected with adverse food reaction.

In some embodiments, a hypoallergenic nutritionally complete dry food composition as disclosed herein can be provided to a companion animal, particularly a puppy, during the time period of growth. In some embodiments, the time period of growth is from about 2 months to about 15 months old. In some embodiments, the time period of growth is from about 2 months to about 8-9 months old. According to these embodiments, the said hypoallergenic nutritionally complete dry food composition can be provided to the companion animal on a daily basis 1 the dog reaches adulthood according to the breed or predicted adult weight.

In some embodiments, the hypoallergenic nutritionally complete dry food composition can be administered, in particular by oral route, to a companion animal depending to a per body weight basis. Administration can be configured based on the size of the companion animal, as well as other factors such as sex, lifestage, age, medical condition, breed, environment, and level of activity, and the like.

In some embodiments, the hypoallergenic nutritionally complete dry food composition can be delivered to the companion animal on a daily basis at a dosage of about 1 g/kg to about 200 g/kg of body weight.

In some embodiments, the hypoallergenic nutritionally complete dry food composition can be delivered to the companion animal on a daily basis at a dosage of about 1 g/kg to about 100 g/kg of body weight.

In some embodiments, the hypoallergenic nutritionally complete dry food composition can be delivered to the companion animal on a daily basis at a dosage of about 1 g/kg to about 50 g/kg of body weight.

In some embodiments, the hypoallergenic nutritionally complete dry food composition can be delivered to the companion animal on a daily basis at a dosage of about 1 g/kg to about 20 g/kg of body weight.

In some embodiments, the hypoallergenic nutritionally complete dry food composition can be delivered to the companion animal on a daily basis at a dosage of about 1, 2, 3, 4, 5, 6, 7, 8, 9, 10, 11, 12, 13, 14, 15, 16, 17, 18, 19 or 20 g/kg of body weight.

It is further contemplated that the uses discussed herein can be employed in conjunction with other food compositions.

It shall be understood that, in the daily practice of feeding animals, the animal owner cannot proceed according to a systemic way of fed the animal with a food composition always on daily basis. However, the beneficial effects of having an optimal development and growth of the companion animal are fully provided when the companion animal is fed with the hypoallergenic nutritionally complete dry food composition described herein every alternate days.

According to another aspect, the present disclosure also relates to a method for reducing the likelihood of occurrence of an adverse food reaction in a companion animal, such as a puppy, said method including at least a step of providing to the puppy a hypoallergenic nutritionally complete dry food composition as described herein. It is believed that companion animals, in particular puppies, can have a genetic predisposition to allergic reactions to certain food compositions leading to a likelihood of occurrence of adverse food reaction.

In some embodiments, the present disclosure also relates to a hypoallergenic nutritionally complete dry food composition as described herein for use in a method for reducing the likelihood of occurrence of an adverse food reaction in a companion animal, such as a puppy.

In some embodiments, an adverse food reaction can consist of a damage of the cutaneous, respiratory, gastrointestinal, and/or cardiovascular systems.

A damage of the cutaneous system can include urticaria, angioedema, alopecia, seborrhoea, pyoderma, and/or pruritus.

A damage of the respiratory system can include of wheezing, coughing, laryngeal edema, rhinorrhea, and/or watery/itching eyes.

A damage of the gastrointestinal system can include vomiting, abdominal pain, and/or diarrhea.

A damage of the cardiovascular system can include angina, heart attacks and/or heart failure.

### Examples

For purpose of understanding and not limitation, the presently disclosed subject matter will be better understood by reference to the following Examples, which are provided as exemplary of the disclosed subject matter, and not by way of limitation.

The present examples 1, 2 and 3 provide a hypoallergenic dry food composition according to the present disclosure along with assessments of its palatability and digestive tolerance when administered to puppies. Example 4 presents results on food acceptance, growth evolution and digestive tolerance of a hypoallergenic dry food composition according to the present disclosure.

### Example 1: Material & Methods

### 1. Test for Assessing Palatability

The palatability of the hypoallergenic dry food composition was determined using a “Two Bowl Test”. This test allows to determine the palatability of a food regarding the food preference of the animal between two different food products.

In this test 30 puppies were enrolled. A hypoallergenic dry food composition and a control food composition were placed in their respective bowls and presented simultaneously to each animal. The bowls are left with the animal for 20 minutes. The amount of food product offered in each bowl is sufficient for the animals' daily caloric intake. The test is performed twice a day. Fresh water was always available. The remaining food product were collected and weighed to determine how much of each food product was consumed by the animal. Each food product is classified alongside the others as a function of its consumption. The palatability was measured according to the diet preference: the percentage of animals which prefer diet A, versus the percentage of animals which prefer diet B, and the percentage of animals which don't have any preference (no choice).

### 2. Test for Assessing Digestive Tolerance

The digestive tolerance of the hypoallergenic dry food composition was determined with the observation of the quality of stool (faecal scoring system).

The study length requires 10 days and pets are fed with the same diet during the 10 days (5 days of acclimatation of the diet and 5 days of fecal collection). No less than 6 animals must complete the study. All animals included in the study are stool graded daily during the fecal collection phase thanks to the fecal score scale hereinafter.

Fecal scoring system for dogs (® Royal Canin, 2017) on a 5-scale:
Score 1: Hard, dry, crumbly stool (crumbs)
Score 2: Dry, very clearly defined cracks
Score 2.5: Clearly defined shape with visible cracks (optimal)
Score 3: Moist stool starting to lose shape and cracks
Score 3.5: Moist stool with no cracks
Score 4: Moist stool with little consistency and no real shape
Score 4.5: Liquid stool with minimal consistency
Score 5: Entirely liquid stool (no texture).

At the end of the study, the mean weighted score is determined for each animal.

Protein indigestibility, measured on Table 5, is the fraction of the protein in a foodstuff that is not assimilated by the animal's digestive system as a % of the total quantity of protein ingested. The protein indigestibility is estimated in our laboratory using the ileal digestibility measuring method or “BOISEN method”. This method is proved to be the best in vitro method to predict the ileal digestibility in monogastric species and is recognized as the reference for in vitro evaluation of digestibility (Boisen S., and Fernandez J A. 1995. “Prediction of the Apparent Ileal Digestibility of Protein and Amino Acids in Feedstuffs and Feed Mixtures for Pigs by in Vitro Analyses.” Animal Feed Science and Technology 51 (1-2): 29-43.).

### 3. Materials

Food product A represents the tested hypoallergenic dry food composition for puppies and the Food product B represents the control food composition, Purina PPVD Canine HA dry Hypoallergenic. Purina PPVD Canine HA is a hypoallergenic food for puppies and adult dogs.

Product A Composition: Hydrolyzed soy protein 23.3% (Threonine 1%), Fat 19%, Fiber: 5.6%, Vitamin C 400 ppm, Vitamin E 700 ppm, Calcium 1.3%, Phosphorus 1%. ME: 4,024 kcal/kg. The composition can also include brewers rice and/or rice flour (source of carbohydrates), fish oil, vegetable oil (soybean oil, safflower oil, borage oil, etc.) poultry fat, beat pulp and palatants.

Product B Composition: Hydrolyzed soy protein 21.0%, fat 10.5%, crude ash 6%, crude fibre 2.0%, carbohydrates 51.5%, Omega 3 fatty acids 0.5%, Omega 6 fatty acids 2%, EPA (eicosapentaenoic acid) and DHA (docosahexaenoic acid) 0.1%, medium chain fatty acids 1.3%. ME: 3,700 kcal/kg.

Thirty puppy dogs were enrolled and completed the trial.

The trial population characteristics are presented in Table 2 below.

TABLE 2
Population Characteristics

| | Hypo puppy |
|---|---|
| Number of puppies | 30 |
| Breed | Several breed (maxi, medium and mini |
| | size breeds) |
| Gender | Male and female |
| Bodyweight | (4-6 BCS) >= 5 kg |
| range (≠BCS) | |
| Age | >6 months for all breed sizes; <8months |
| | small and medium/<12 months maxi |
| Repartition | Three groups of 10 healthy puppies allocated |
| | to their adult weight range |
| Test duration | 8 weeks |

### Example 2: Palatability Results

The results of the two-bowl test assessing palatability are presented on Table 3 below.

TABLE 3
Palatability results

| | |
|---|---|
| Number of puppies | 30 |
| Preference | A: 81%/B: 19%/No choice: 3% |
| Preference probability | 0.000000 (VHS) |
| First Choice | A: 85% \| B: 15% |
| First Choice Probability | 0.000000 (VHS) |

The hypoallergenic dry food composition of the present disclosure is very highly significantly preferred as compared to product Purina PPVD Canine HA hypoallergenic dry (VHS=stats showed very highly significant differences), all dogs consumed the diet fully.

Therefore, the hypoallergenic nutritionally complete dry food composition is palatable and well accepted for puppies of any breed and does not cause food aversion.

### Example 3: Digestive Tolerance Results

The results on stools, digestibility and body weight variation for all dogs included in the study are presented below.

TABLE 4
Distribution of stools quarter for the dogs

| Fecal scoring | Percentage of dogs |
|---|---|
| Very Soft (Score 1) | 13% |
| Soft (Score 2) | 46% |
| Optimal/Total (Score 2.5) | 26% |
| Hard (Score 3) | 15% |
| Very Hard (Score 3.5-5) | 0% |

The optimal target fecal score was 2.5 (optimal score in the fecal scoring usual scale). The average fecal score obtained was 2.8. Therefore, the hypoallergenic dry food composition of the present disclosure is well tolerated and digestible by the dogs. There was no report of diarrhea.

TABLE 5
Mean results on the digestibility of all the enrolled dogs

| | Dry matter | Protein |
|---|---|---|
| | digestibility | digestibility |
| | coefficient (%) | coefficient |
| Mean of all dogs | 83.6 | 87.7 |
| Standard deviation (SD) | 2.2 | 3 |

For reference, a diet having a digestibility of dry matter of 83% or more and a digestibility of proteins of 86% or more is considered to be a highly digestible food composition. A diet having a digestibility of dry matter of 81% or more and a digestibility of proteins of 83% or more is considered to be a standard food composition.

TABLE 6
Body weight variation, in 10 days collection, during the test

| | Initial Weight | Final Weight | Variation of the |
|---|---|---|---|
| | [Min-Max] | [Min-Max] | weight [Min-Max] |
| Mean dogs | 32.1 kg | 32.2 kg | 0.1 |
| | [21.76 kg-39.54 kg] | [21.5 kg-40 kg] | [−0.62-0.96] |

The puppies maintained good body weight (no loss >5% in 10 days collection) which confirms the dogs ate the food composition consistently and achieved their energy requirements.

### Example 4: Results for Acceptance, Growth Evolution, and Digestive Tolerance

The present example present results on food acceptance, growth evolution and digestive tolerance of a hypoallergenic dry food composition according to the present disclosure.

### 4.1 Tests

It has been tested the food composition A on a population of puppies for 60 days. This study was followed by veterinarians.

The food composition A, same as in Example 1, has the following composition: Hydrolyzed soy protein 23.3% (Threonine 1%), Fat 19%, Fiber: 5.6%, Vitamin C 400 ppm, Vitamin E 700 ppm, Calcium 1.3%, Phosphorus 1%. ME: 4,024 kcal/kg. The composition can also include brewers rice and/or rice flour (source of carbohydrates), fish oil, vegetable oil (soybean oil, safflower oil, borage oil, etc.) poultry fat, beat pulp and palatants.

Size of one kibble: 11 mm×10.5 mm×5 mm.

The trial characteristics are presented in Table 7 below.

TABLE 7
Characteristics

| | Hypo puppy |
|---|---|
| Number of puppies | 11 |
| Breed | Several breed (maxi, medium and mini |
| | size breeds) |
| Gender | Male and female |
| Age | From 5 months to 12 months |
| Test duration | 60 days |

### 4.2 Food Acceptance Results

To assess the food acceptance of the hypoallergenic dry food composition among the puppies, it was evaluated, based on scores provided by the owners, the following categories:
(a) the easiness to eat of the diet (Score: Ranging from 1 [very difficult] to 9 [very easy]),
(b) Amount of food consumed per meal by the animal (Score: Ranging from 1 [none of the food offered was eaten] to 9 [all of the product offered was eaten]),
(c) Enjoyment of the diet by the animal (Score: Ranging from 1 [puppy did not enjoy at all] to 9 [puppy enjoyed extremely], and
(d) Assessment of the kibble by the pet owner (For the kibble size: Score ranging from 1 [much too big] to 3 [just about right] to 5 [much too small]. For kibble texture: Score ranging from 1 [much too hard] to 3 [just about right] to 5 [much too soft]. For the “chewiness” of the kibble: Score ranging from 1 [not nearly chewy enough] to 3 [just about right] to 5 [much too chewy]).

Results based on the average scores from the pet owners:
a. The diet was considered “very easy” to eat for 9 puppies and “easy to eat” for the remaining puppies.
b. Eight puppies consumed all the food offered, and the remaining puppies ate more than half of the food offered. Therefore, the food was consumed in appropriate quantities.
c. All pet owners reported that their puppies enjoy the food composition, with 9 owners indicating that their puppies enjoyed the food extremely. Furthermore, most of the puppies enjoyed the food composition more than their previous diet.
d. More than half of the pet owner found the kibble size to be “just about right” (score 3). All pet owners found that the kibble texture to be “just about right”. Finally, 9 pet owners rated the kibble “chewiness” as “just about right” (score 3).

In conclusion, the hypoallergenic dry food composition of the present invention has kibble features adapted to growing puppies and is palatable.

### 4.3 Growth Evolution Results

To assess the growth evolution of puppies fed with the hypoallergenic dry food composition, it was evaluated the Body Weight (BW) evolution and the Body Condition Score (BCS) evolution of the puppies.

Evolution of the average body weight (in kilograms) for the growing puppies fed with the food composition is shown in Table 8 below:

TABLE 8
Evolution of the average body weight for the growing puppies

| | Day 0 | Day 10 | Day 30 | Day 60 |
|---|---|---|---|---|
| Average puppies body | 19.2 kg | 20.6 kg | 22.2 kg | 23.5 kg |
| weight (kilograms) | | | | |

The results show that the evolution of Body Weight follows the classical trend observed in growing puppies for that age and size, with a slight progressive increase over time.

The body condition score evolution results are shown in Table 9 below:

TABLE 9
Body Condition Score evolution

| | Day 0 | Day 10 | Day 30 | Day 60 |
|---|---|---|---|---|
| Average puppies BCS | 4 | 4.3 | 4 | 4.3 |

The results show that the BCS remains within correct limits (around 4-5). When interpreted in parallel with the body weight (BW) evolution, this suggests that the progressive increase in weight is not associated with an increase in fat mass but rather with an increase in lean body mass, which is favorable for the puppy.

### 4.4 Digestive Tolerance Results

To evaluate the digestive tolerance of the hypoallergenic dry food composition in puppies, it has been assessed the consistency of the feces and the fecal frequency of the puppies.
a. The results indicate that the stools exhibited good consistency, with fecal scores consistently falling between 2 and 4. There were no scores of 1 or 4.5-5. The average fecal score (FS [D10-D30]) was 2.65, which falls within the range considered as ‘optimal’ for puppies.
b. It has been observed a notable enhancement in the frequency of defecation during the study, with no puppies exhibiting bowel movements 4-5 times per day by the end of the study. The overall results regarding digestive tolerance are highly favorable.

### CONCLUSION

As supported by the examples above, the present disclosure successfully provides a well-tolerated, highly digestible and palatable new hypoallergenic nutritionally complete dry food composition, including ingredients which provide hydrolyzed vegetal protein and an optimal nutritional level of proteins, vitamins, calcium, phosphorus, threonine and/or fat.

In particular, this hypoallergenic nutritionally complete dry food composition is preferably formulated for a young companion animal, preferably a young dog (puppy), especially those susceptible or predisposed to adverse food reaction or those suffering from adverse food reaction.

The hypoallergenic nutritionally complete dry food composition as described herein does not provoke allergic reaction in companion animals. In particular, the hypoallergenic nutritionally complete dry food composition of the present disclosure is formulated to avoid or at least minimized the risk of a food aversion.

Although the presently disclosed subject matter and its advantages have been described in detail, it should be understood that various changes, substitutions and alterations can be made herein without departing from the spirit and scope of the disclosed subject matter as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the presently disclosed subject matter, processes, machines, manufacture, compositions of matter, means, methods, or steps, presently existing or later to be developed that perform substantially the same function or achieve substantially the same result as the corresponding embodiments described herein can be utilized according to the presently disclosed subject matter. Accordingly, the appended claims are intended to include within their scope such processes, machines, manufacture, compositions of matter, means, methods, or steps.

Patents, patent applications, publications, product descriptions and protocols are cited throughout this application the disclosures of which are incorporated herein by reference in their entireties for all purposes.

### REFERENCES

Aldrich G C, Koppel K. Pet Food Palatability Evaluation: A Review of Standard Assay Techniques and Interpretation of Results with a Primary Focus on Limitations. Animals (Basel). 2015 Jan. 16; 5 (1): 43-55. doi: 10.3390/ani5010043. PMID: 26479136; PMCID: PMC4494336.
Baldwin Kimberly, Joe Bartges, Tony Buffington, Lisa M. Freeman, Mary Grabow, Julie Legred, Donald Ostwald, Jr., AAHA Nutritional Assessment Guidelines for Dogs and Cats, JOURNAL of the American Animal Hospital Association, July/August 2010, Vol. 46, pages 285-296.
Boisen S., and Fernandez J A. 1995. “Prediction of the Apparent Ileal Digestibility of Protein and Amino Acids in Feedstuffs and Feed Mixtures for Pigs by in Vitro Analyses.” Animal Feed Science and Technology 51 (1-2): 29-43.
Calvez J, Weber M, Ecochard C, et al. Metabolisable energy content in canine and feline foods is best predicted by the NRC2006 equation. PLOS One. 2019; 14 (9): e0223099. Published 2019 Sep. 27. doi: 10.1371/journal.pone.0223099
G. Fauconneau. DOSAGE DES PROTÉINES ET DES ACIDES AMINÉS ET DÉTERMINATION DE LEUR VALEUR NUTRITIVE. (1). Annales de zootechnie, INRA/EDP Sciences, 1956, 5 (3), pp. 255-274. ffhal-00886656
Hefle S L, Nordlee J A, Taylor S L. Allergenic foods. Crit Rev Food Sci Nutr. 1996; 36 Suppl: S69-89.
Rutherfurd S M, Gilani G S. Amino acid analysis. Curr Protoc Protein Sci. 2009 November; Chapter 11: Unit 11.9. doi: 10.1002/0471140864.ps1109s58. PMID: 19937719.
Verlinden A, Hesta M, Millet S, Janssens G P. Food allergy in dogs and cats: a review. Crit Rev Food Sci Nutr. 2006; 46 (3): 259-73.

1. A hypoallergenic nutritionally complete dry food composition for a puppy, wherein said composition comprises:
from about 20% to about 25% by weight of vegetal proteins, said vegetal proteins comprising at least about 95% by weight of hydrolyzed vegetal proteins, from about 15% to about 25% by weight of fat,
from about 200 ppm to about 500 ppm by weight of vitamin C,
from about 400 ppm to about 900 ppm by weight of vitamin E,
from about 0.5% to about 2% by weight of calcium (Ca),
from about 0.5% to about 1.5% by weight of phosphorus (P), and
from about 0.5% to about 1.5% by weight of threonine (Thr),
the weight percentage and ppm being expressed on a dry matter basis.

2. The dry food composition according to claim 1, wherein the vegetal proteins include at least about 99% by weight of hydrolyzed vegetal proteins on a dry matter basis.

3. The dry food composition according to claim 1, wherein the hydrolyzed vegetal proteins have a molecular weight of 30,000 Da or less.

4. The dry food composition according to claim 1, wherein a source of hydrolyzed vegetal protein is soya, rice, and/or a combination thereof.

5. The dry food composition according to claim 1, wherein a source of fat comprises a vegetal fat source and/or an animal fat source.

6. The dry food composition according to claim 5, wherein the vegetal fat source is selected from wheat, sunflower, safflower, rapeseed, olive, borage, flaxseed, peanuts, blackcurrant seed, cottonseed, germ, corn germ, algae, and/or a combination thereof, and/or the animal fat source is selected from fish oil, krill oil, and/or a combination thereof.

7. The dry food composition according to claim 1, further comprises from about 3% to about 8% by weight of fibers based on dry matter basis.

8. The dry food composition according to claim 1, further comprises from about 3% to about 7% by weight of lutein based on a dry matter basis.

9. The dry food composition according to claim 1, further comprises from about 0.1% to about 2% of taurine based on a dry matter basis.

10. The dry food composition according to claim 1, further comprises from about 1.5 ppm to about 10 ppm by weight of beta-carotene based on a dry matter basis.

11. The dry food composition according to claim 1, the puppy being less than about 15 months.

12. (canceled)

13. A method for reducing the likelihood of occurrence of adverse food reaction in a puppy, said method comprising at least a step of providing to the puppy a hypoallergenic nutritionally complete dry food composition according to claim 1.

14. A method of manufacturing a hypoallergenic nutritionally complete dry food composition, comprising the step of:
a) mixing ingredients of the hypoallergenic nutritionally complete dry food composition according to claim 1, thereby obtaining a mixture, and
b) heating the mixture, obtaining the hypoallergenic nutritionally complete dry food composition.
